(19) United States
(12) Patent Application Publication
(10) Pub. No.: US 2008/0145683 A1
(43) Pub. Date: Jun. 19, 2008

(54) METHOD FOR TREATING SURFACE OF POLYMER ARTICLE

(75) Inventor: GA-LANE CHEN, Santa Clara, CA (US)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/779,240

(22) Filed: Jul. 17, 2007

(30) Foreign Application Priority Data
Dec. 15, 2006 (CN) 200610157545.9

(51) Int. Cl. B32B 23/04

(52) U.S. Cl. 428/532; 204/192.15

(57) ABSTRACT

A method for treating a surface of a polymer article is includes steps of: generating a gas plasma with a working gas using an electric glow discharge device (step 101); treating a surface portion of the polymer article using the gas plasma so as to convert the surface portion into a glow discharge treatment layer (step 102); forming a basecoat layer on the glow discharge treatment layer (step 103); forming a metallic layer on the basecoat layer (step 104); and forming an overcoat layer on the metallic layer (step 105). A polymer structure (300) includes a polymer article (310), a glow discharge treatment layer (320), a basecoat layer (330), a metallic layer (340), and an overcoat layer (350).

### BACKGROUND OF THE INVENTION

1. Field of the Invention

The invention relates to surface treatment of polymer articles, and particularly to a method for treating a surface of a polymer article by glow discharge and a polymer structure treated by the method.

2. Description of Related Art

Many consumer products use polymers to be their case materials, such as mobile phones, notebooks and digital cameras. For various applications, many of the industrially manufactured polymers possess the desirable characteristics with respect to bulk properties, such as chemical and mechanical stability, elasticity, thermoplasticity, etc., but are deficient with respect to the characteristics of their surfaces. Such deficiencies include lack of biocompatibility, lack of comparability with water and polar solvents, incapacitance to accommodate chemical charges and to interact or react with chemical substrates of particular interest.

In order to correct such deficiencies, a more rational approach is the surface modification of such polymers to give them the desired surface characteristics. A conventional method for the above stated surface deficiencies is introduction of specific polar groups into such polymer surfaces. Polar functional groups have been introduced to the polymer surfaces by chemical methods, such as chromium trioxide oxidation, physical methods, such as corona treatment, and via introducing small functionalized molecules to the surface. In the later case, the long aliphatic chains of tridodecyl methyl ammonium chloride were absorbed into the swollen surface of the polymer to be modified leaving a polar function group at the surface.

However, the conventional surface treatment methods have some drawbacks. For example, after the vast majority of poling procedures, unstable hetero- and/or homocharges are present in the polymer. Theses unstable charges will influence the adhesion of additional coating films on the polymer. Besides, the conventional methods cannot get rid of undesired water molecules on the polymer surface thoroughly.

What is needed, therefore, is a method for treating a surface of a polymer articles that can enhance the adhesion of coating films on the polymer article and can get rid of undesired water molecules on the polymer article's surface thoroughly.

### SUMMARY OF THE INVENTION

A method for treating a surface of a polymer article is provided. In one embodiment, the method for treating a surface of a polymer article includes steps of:

generating a gas plasma with a working gas using an electric glow discharge device;

treating a surface portion of the polymer article using the gas plasma so as to convert the surface portion into a glow discharge treatment layer;
forming a basecoat layer on the glow discharge treatment layer;
forming a metallic layer on the basecoat layer; and
forming an overcoat layer on the metallic layer.

The electric glow discharge device comprises a chamber, a first electrode, a second electrode, a vacuum pump and a RF power supply with a frequency from 13.56 MHz, to Gigahertz-scale or microwave frequency. The working gas is selected from a group consisting of oxygen (O₂), methane (CH₄), carbon tetrafluoride (CF₄), ethane (C₂H₆), a combination of argon (Ar) and CH₄, a combination of Ar and O₂, and any combination thereof.

A polymer structure is also provided. The polymer structure includes a polymer article, a glow discharge treatment layer, a basecoat layer, a metallic layer, and an overcoat layer. The glow discharge treatment layer is formed on the polymer article. The basecoat layer is formed on the glow discharge treatment layer. The metallic layer is formed on the basecoat layer. The overcoat layer is formed on the metallic layer.

Advantages and novel features of the present method for treating a polymer article and the polymer structure using the same will become more apparent from the following detailed description of preferred embodiments when taken in conjunction with the accompanying drawings.

### BRIEF DESCRIPTION OF THE DRAWING

The components in the drawing are not necessarily drawn to scale, the emphasis instead being placed upon clearly illustrating the principles of the present invention.

FIG. 1 is a schematic flow chart of a method for treating a surface of a polymer article in accordance with a preferred embodiment of the present invention;

FIG. 2 is a schematic, cross-sectional view of an electric glow discharge device for treating the polymer article; and

FIG. 3 is a schematic, cross-sectional view of a polymer structure treated by the method of FIG. 1.

Corresponding reference characters indicate corresponding parts. The exemplifications set out herein illustrate at least one preferred embodiment of the present method for treating a surface of a polymer article and a polymer structure treated by the method, in one form, and such exemplifications are not to be construed as limiting the scope of the invention in any manner.

### DETAILED DESCRIPTION OF THE INVENTION

Reference will now be made to the drawings to describe embodiments of the present method for treating a surface of a polymer article and a polymer structure treated by the method in detail.

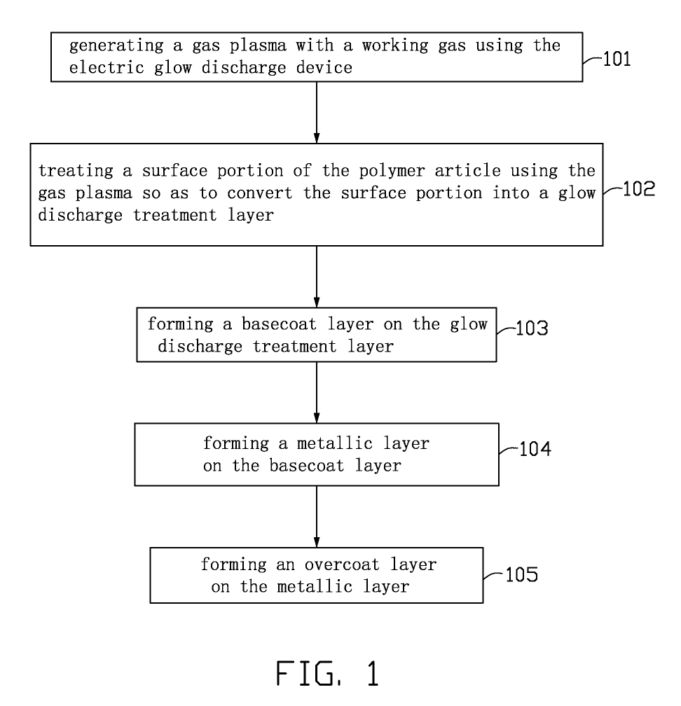

Referring to FIG. 1, a method for treating a surface of a polymer article according to a first preferred embodiment of the present invention is shown. The method for treating a surface of a polymer article includes steps of:

generating a gas plasma with a working gas using an electric glow discharge device (step 101);

treating a surface portion of the polymer article using the gas plasma so as to convert the surface portion into a glow discharge treatment layer (step 102);
forming a basecoat layer on the glow discharge treatment layer (step 103); forming a metallic layer on the basecoat layer (step 104); and
forming an overcoat layer on the metallic layer (step 105).

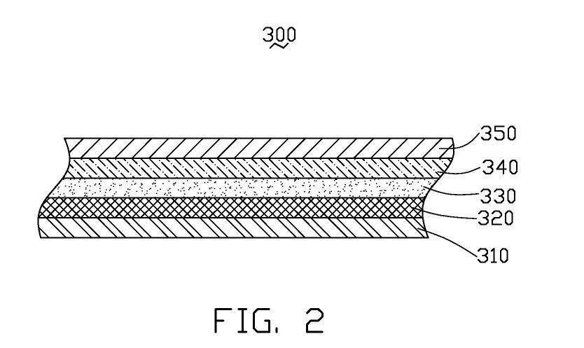

Referring to FIG. 2 showing an electric glow charge device 200, the electric glow discharge device 200 includes a chamber 210, a first electrode 220, a second electrode 230, a vacuum pump 240 and a RF power supply 250 with frequency from 13.56 MHz, to Gigahertz-scale or microwave frequency.

The electric glow discharge device 200 further includes a gas inlet 260. Working gases in the electric glow discharge device 200 are selected from a group consisting of O₂, CH₄, CF₄, C₂H₆, a combination of Ar and CH₄, a combination of Ar and O₂, and any combination thereof. The electric glow discharge device 200 further includes magnetic coils 270 surrounding the chamber 210 for using a magnetic field to enhance plasma density.

In step 101, a polymer article 310 is placed between the first electrode 220 and the second electrode 230 at first. The first electrode 220 and the second electrode 230 are connected with the RF power supply 250. The vacuum pump 240 is used to evacuate the chamber 210 to a high vacuum status. Subsequently, the working gases are injected into the chamber 210 via the gas inlet 260. The chamber 210 is filled with the working gases.

A potential of several hundred volts is applied between the first electrode 220 and the second electrode 230. A small number of atoms within the chamber 210 are initially ionized through random processes. The ions (which are positively charged) are driven towards the second electrode 230 (cathode) by the electric potential, and the electrons are driven towards the first electrode 220 (anode) by the same potential. The initial population of ions and electrons collides with other atoms, ionizing them. As long as the potential is maintained, a population of ions and electrons remains. Some of the ions' kinetic energy is transferred to the cathode. Some of ions strike the more numerous neutral gas atoms, transferring a portion of their energy to them. These neutral atoms then strike the second electrode 230.

This process is known as glow discharge polymerization. A surface of the polymer article 310 is polymerized by glow discharge. The effect of polymerization is proportional to the plasma density. In atomic mass spectrometry, these ions are detected. Their mass identifies the type of atoms and their quantity reveals the amount of that element in the polymer article 310.

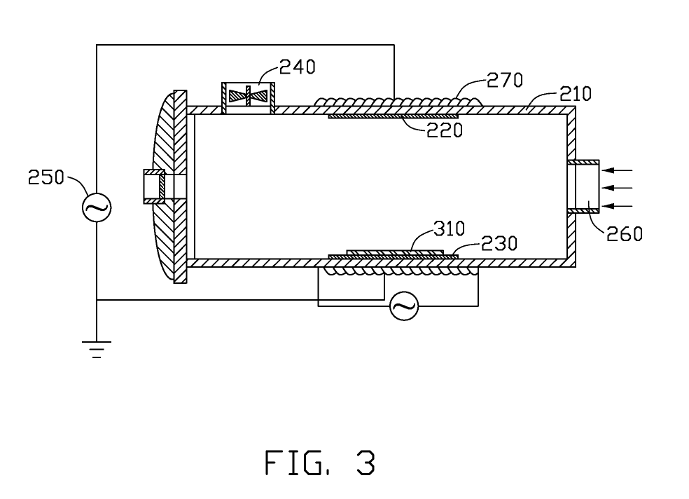

Referring to FIG. 3, a polymer structure 300 treated by above-described method is shown. The polymer structure 300 includes a polymer article 310, a glow discharge treatment layer 320 by glow discharge, a basecoat layer 330, a metallic layer 340, and an overcoat layer 350.

The glow discharge treatment layer 320 is formed on the polymer article 310 by glow discharge. The basecoat layer 330 can be formed on the glow discharge treatment layer 320 by spraying. The basecoat layer 330 can be a lacquer layer with various colors, such as black, silver, blue, white, red and etc. The metallic layer 340 can be formed on the basecoat layer 330 by sputtering. A material of the metallic layer 340 can be selected from the group consisting of alumina (Al), silver (Ag), titanium nitride (TiN), titanium carbide (TiC) and silicon nitride (Si₃N₄). The metallic layer 340 can add metallic color to the lacquer layer 330. The overcoat layer 350 can be formed on the metallic layer 340 by spraying. The overcoat layer 350 is comprised of diamond-like crystal or silicon dioxide (SiO2). The overcoat layer 350 is used for protecting the metallic layer 340.

The present invention uses glow discharge polymerization method and multilayer structure to enhance surface reliability of polymers. The present method for treating a polymer article can get rid of undesired water molecules on the polymer article surface, thus enhancing the adhesion of coating films on a polymer article. Also, after glow discharge process and multilayer coating, the optical appearance and reflectivity of the polymer structure will be enhanced.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. A method for treating a surface of a polymer article, comprising:
generating a gas plasma with a working gas using an electric glow discharge device;
treating a surface portion of the polymer article using the gas plasma so as to convert the surface portion into a glow discharge treatment layer;
forming a basecoat layer on the glow discharge treatment layer;
forming a metallic layer on the basecoat layer; and
forming an overcoat layer on the metallic layer.

2. The method as claimed in claim 2, wherein the working gas is selected from a group consisting of oxygen (O₂), methane (CH₄), carbon tetrafluoride (CF₄), ethane (C₂H₆), a combination of argon (Ar) and CH₄, a combination of Ar and O₂, and any combination thereof.

3. The method as claimed in claim 1, wherein the basecoat layer is a lacquer layer.

4. The method as claimed in claim 1, wherein a material of the metallic layer is selected from the group consisting of alumina (Al), silver (Ag), titanium nitride (TiN), titanium carbide (TiC) and silicon nitride (Si₃N₄).

5. The method as claimed in claim 4, wherein the metallic layer is formed by sputtering.

6. The method as claimed in claim 1, wherein the overcoat layer is comprised of diamond-like crystal or silicon dioxide (SiO₂).

7. A polymer structure, comprising:
a polymer article;
a glow discharge treatment layer formed on the polymer article using an electric glow discharge device;
a basecoat layer formed on the glow discharge treatment layer;
a metallic layer formed on the basecoat layer; and
an overcoat layer formed on the metallic layer.

8. The polymer structure as claimed in claim 7, wherein the basecoat layer is a lacquer layer.

9. The polymer structure as claimed in claim 7, wherein a material of the metallic layer is selected from the group consisting of Al, Ag, TiN, TiC and Si₃N₄.

10. The polymer structure as claimed in claim 7, wherein the metallic layer is made by a sputtering method.

11. The polymer structure as claimed in claim 7, wherein the overcoat layer is comprised of diamond-like crystal or SiO2.
